(19) United States
(12) Patent Application Publication
(10) Pub. No.: US 2007/0171827 A1
(43) Pub. Date: Jul. 26, 2007

(54) Network flow analysis method and system

(76) Inventors: Mark E. Scott, Bondville, IL (US); John G. Ronk, Oak Park, IL (US)

Correspondence Address: OLSON & HIERL, LTD., 20 NORTH WACKER DRIVE, 36TH FLOOR, CHICAGO, IL, 60606, US

(21) Appl. No.: 11/338,014

(22) Filed: Jan. 24, 2006

(51) Int. Cl. H04J 1/16

(52) U.S. Cl. 370/235; 370/392

(57) ABSTRACT

Methods, systems, and articles of manufacture to uniquely identify network application flows. Upon detecting a network application flow, data is obtained from the flow and is used to prepare a unique data identifier, referred to as a global flow ID. Multiple stations monitoring network flow at different points in the network can, with the present invention, compute the same global flow ID for local detections of the same network application flow. The monitoring stations can report flow observations and metrics to a centralized analysis resource without retransmitting the flow data.

### FIELD OF THE INVENTION

This present invention pertains to the unique identification of network flow elements, such as network application flows and the monitoring of such flows.

### BACKGROUND OF THE INVENTION

With increasing regularity, significant investments are being made to deploy network-wide business applications. Today's enterprise organizations depend heavily on the business applications that run their business. Business managers are coming to realize that the end goal of “high availability” of a particular application is no longer the only indicator of a successful application environment. Availability alone is insufficient. If an application is available, but is not used effectively, for whatever reason, value in its investment is lost. If management or others determine that an application is critical to the operating efficiency of a business, opportunities to increase business efficiency are lost if the application is not employed to the extent intended. All of these factors, and more, may be summarized by the “usability” of an application. Oftentimes, operation of an application, such as one related to network messaging or telecommunications, can be difficult to monitor, especially if it is employed over a complex, highly distributed network.

The concept of application program “usability” relates to the acceptance of an application by employees or other operators of a business activity. Application usability is important to users who communicate over a network and to work administrators and other members of a business concern who rely on the application software to complete their daily tasks. However, it has been found difficult to effectively analyze usability in complex systems operating in a real world environment. It is important that such analysis be proactive, so that potential problems can be identified before they impact the service to an end-user. The concept of “usability” relates to measurement of performance from the point of view of an end-user. Included are responsiveness and performance consistency of the application as perceived by the end-user. Emphasis on the ability to quickly analyze application performance is becoming more and more critical to successful business operation as dependence on business applications increases.

Of all the communications that occur over a network, exchanges of information can be divided into “flows”. A flow is a collection of packets that constitutes a message exchange between two computing end-points. As an example, consider the typical request/response exchange in a client-server environment or the continuous stream of multi-media packets in a VoIP conversation. Flow analysis is critical to understanding application performance, because it measures the actual application characteristics as they occur to the end-user. In most environments, a flow is a collection of many application message exchanges that occur over relatively long periods of time. As conditions change, in order for measurements of application performance to be meaningful, measurements must go beyond the setup, network utilization, and termination of a flow.

In the past, certain solutions have been offered to assist management in evaluating the performance of network distributed application programs. For example, Network Associates, Inc., offered a tool called the Network General Sniffer™ multi-trace option. This tool helped to automate the network capture process from multiple analysis points within a corporate network. It is based upon a post-processing model where synchronized network captures are obtained from multiple points within a network. The captured data is retrieved to a central location across the network, where it is correlated to provide a picture of the networked activity. However, advances in the field of network analytical tools are still being sought.

### SUMMARY OF THE INVENTION

The present invention provides a novel and an improved system, method, and article of manufacture for uniquely identifying a network application flow using a message digest, or hashing algorithm. A system provides a global flow ID for a network application flow traveling in a network between a server host and a client host. The network application flow has at least one of the following characteristics: at least one protocol ID for the network application flow, a port used by the server host, a port used by the client host, a network address or a media access control address used by the server host for the network application flow, and a network address or a media access control address used by the client host for the network application flow. The system includes at least one monitoring station having a module for monitoring the network application flow, and a module for obtaining from the network application flow, at least one of the characteristics of the network application flow. Preferably, the global flow ID comprises a message digest and the monitoring station includes a module for calculating the global flow ID with a hashing algorithm, using one or more of the network application flow characteristics and a network timestamp as inputs to the hashing algorithm. A module transmits the global flow ID to a flow analysis center for correlation with reports from other monitoring stations, or other sources.

A method is provided for uniquely identifying a network application flow traveling between a server host and a client host, for network flow analysis. The network application flow has at least one of the following characteristics: at least one protocol ID for the network application flow, a port used by the server host, a port used by the client host, a network address or a media access control address used by the server host for the network application flow, and a network address or a media access control address used by the client host for the network application flow. The method comprises reviewing the network application flow, and obtaining from the network application flow at least one of the characteristics of the network application flow. The method further comprises calculating a global flow ID unique to the network application flow with a hashing algorithm to create a message digest comprising the global flow ID, using one or more of the network application flow characteristics and a network timestamp as inputs to the hashing algorithm. The method includes a step of transmitting the global flow ID to a flow analysis center for processing.

Another method is provided for analyzing a network application flow traveling between a server host and a client host and having the following flow characteristics: at least one protocol ID for the network application flow, a port used by the server host, a port used by the client host, either a network address or a media access control address used by the server host for the network application flow, and either a network address or a media access control address used by the client host for the network application flow. The method includes the step of observing the network application flow and obtaining from the network application flow a number of the flow characteristics of the network application flow. If the network includes at least one server host and at least two client hosts or the network includes at least one client host and at least two server hosts, then at least five of the flow characteristics are used as inputs to the global flow ID calculation. However, if the network contains only one client host and one server host, then at least three of the flow characteristics are used as inputs to the global flow ID calculation. The method further includes the step of calculating a global flow ID unique to the network application flow with a hashing algorithm to create a message digest comprising the global flow ID, using the flow characteristics and a network timestamp related to the network application flow, as inputs to the hashing algorithm. A network analysis center is provided for analyzing the network application flow, and the method includes with transmitting the global flow ID to the network analysis data.

An article of manufacture includes a machine readable medium for causing a computer system to provide a global flow ID comprising a message digest and uniquely identifying a network application flow traveling in a network between a server host and a client host. The network application flow has at least one of the following characteristics: at least one protocol ID for the network application flow, a port used by the server host, a port used by the client host, a network address or a media access control address used by the server host for the network application flow, and a network address or a media access control address used by the client host for the network application flow. The article of manufacture includes a module for monitoring the network application flow, and a module for obtaining from the network application flow, at least one of the characteristics of the network application flow. Also included is a module for calculating the global flow ID with a hashing algorithm, using one or more of the network application flow characteristics and a network timestamp as inputs to the hashing algorithm. A module is included for transmitting the global flow ID to a flow analysis center.

### BRIEF DESCRIPTION OF THE DRAWINGS

FIG. 1 is a schematic diagram of a network;

FIG. 2 is a schematic diagram showing communications across the network shown in FIG. 1;

FIG. 3 is a schematic representation of a flow analysis center and monitoring stations implementing the present invention;

FIG. 4 is a schematic representation of a flow analysis center implementing the present invention;

FIG. 5 is a schematic flow diagram of the operation of the network of FIG. 1;

FIG. 6 is a schematic flow diagram showing the preparation and binding of identification indicia to flow elements of the network of FIG. 1; and

FIG. 7 is a schematic diagram showing another set of communications across the network shown in FIG. 1.

### DETAILED DESCRIPTION OF THE PREFERRED EMBODIMENT

The invention disclosed herein is, of course, susceptible of embodiment in many different forms. Shown in the drawings and described hereinbelow in detail are preferred embodiments of the invention. It is the understood, however, that the present disclosure is an exemplification of the principles of the invention and does not limit the invention to the illustrated embodiments.

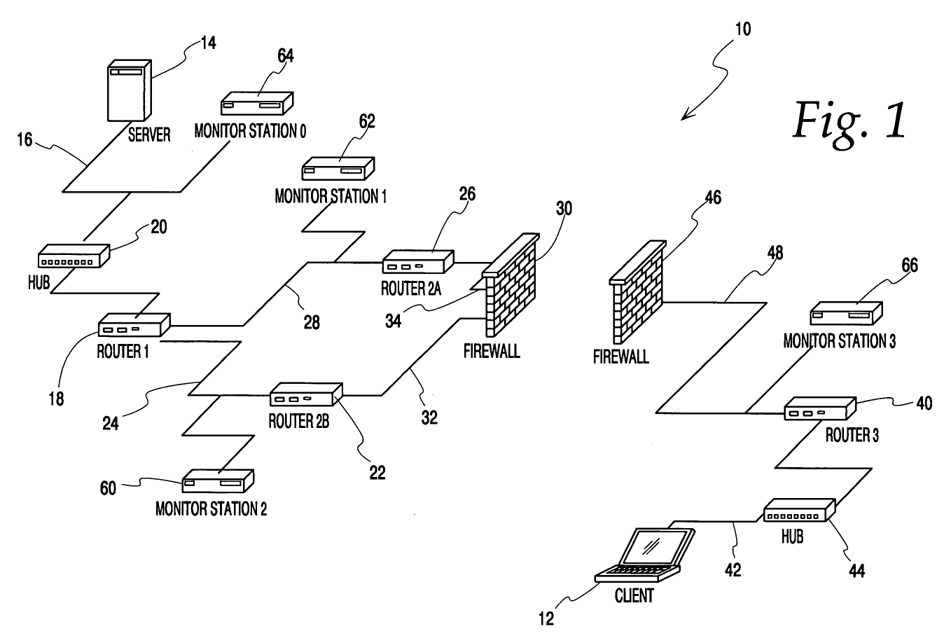

Turning now to the drawings, and initially to FIG. 1, a schematic representation of a computing network is shown. Network 10 allows communication between one or more users, such as client 12 and data center 14. In one instance, data center 14 includes one or more servers or server hosts, and client 12 includes one or more client computers or client hosts. A number of network paths connect data center 14 to client 12. For example, network path 16 connects data center 14 to a router 18, through a hub 20. Router 18 is coupled to router 22 via network path 24, and to router 26 via network path 28. Routers 22, 26 are coupled to firewall 30 by network paths of 32, 34 respectively. Client 12 is coupled to router 40 through network path 42, which extends through hub 44. Router 40 is coupled to firewall 46 via network path 48.

Network 10 can take virtually any form and may employ, for example, either cable or wireless components. Network 10 can be configured as an open connection or network such as the internet network, a wide area network, a telephone network, a satellite data network, an on-line network or any intra-facility network, for example. Network 10 can also take the form of any Ethernet, Token-Ring or optical data network arrangement or configuration that can link workstations, particularly workstations including one or more data processing computers. Communications between data center 14 and client 12 can employ virtually any communications technology known today. The geographical spacing between the data center and the client 12 can have virtually any scale desired. For example, the entire network 10 can be located in a single room, or in a single building or building complex or campus. If desired, network 10 can provide communications either within or across local, state, federal, national or international boundaries. For example, client 12 can be located in one or more boundaries different from those of data center 14. Further, data center 14 or client 12 may communicate with external entities located within the same or within different political or geographic boundaries.

Communications between data center 14 and client 12 can take virtually any form known today. The present invention finds immediate acceptance for communications relating to network application programs, or network applications, such as those relied upon in day to day operations of an organization. In one instance, communications relating to network application programs are organized in flows comprising a collection of packets that constitute a message exchange between two computing endpoints, such as the endpoints comprised of data center 14 and client 12. Examples of flows include, in one instance, the typical request/response exchange in a client-server environment, and in another instance the continuous stream of multimedia packets in a VoIP conversation. As will be seen herein, the present invention finds particular application in the analysis of network information flows, such as network application flows. Flow analysis is critical to understanding application performance because it provides measurements or metrics of actual, real world application and other types of network flow characteristics, as they appear to the end-user, such as client 12. In a typical network environment, the flows comprise a collection of many application message exchanges that occur over prolonged periods of business activity. As conditions change, measuring the setup, network utilization, and end point flow does not provide sufficient insight into the behavior experienced by the end-user.

In order to carry out network flow analysis, a plurality of monitoring stations are employed throughout network 10. Referring to FIG. 1, monitoring station 64 is located between server 14 and hub 20. Monitoring station 60 is located in the network path 24, between router 18 and router 22, as part of the overall path between data center 14 and firewall 30. Monitoring station 62 is located in a network path 28, between router 18 and router 26. Thus, monitoring stations 60, 62 are employed to intercept network communications sent from one computing endpoint, herein data center 14. Monitoring stations 60, 62 are employed in one instance, to detect trouble spots in the network 10 more closely associated with data center 14 than the other network components.

On the other side of the firewalls 30, 46, monitoring station 66 is located in network path 48, between the router 40 and the firewall 46, part of the overall path between client 12 and the firewall connection. As mentioned above, client 12 can be located at an endpoint of network 10 physically remote from the computing endpoint of data center 14. Monitoring station 66 is positioned to detect trouble spots in network 10 more closely associated with client 12 than other network components. In one instance, monitoring stations 60, 62 and 66 are employed to perform network analysis from multiple observation points throughout network 10, using conventional equipment (such as the Application Performance Analyzer Commercially available from Nexvu Technologies of Schaumburg, Ill.) and other resources available from Nexvu Technologies, Inc., assignee of the present invention, located in Schaumburg, Ill. For example, network flow analysis can include a protocol analyzer to capture packets transmitted throughout network 10. As is known, the protocol analyzer provides a network packet recording functionality which allows assembly of a directory of all known protocols employed throughout network 10. Protocol IDs are the identifying numbers for communication protocols used to transmit information throughout a network. Such identifying members can be assigned by the Internet Assigned Numbers Authority (IANA) and stored in a protocol directory. A protocol, as used herein, is a special set or suite of formal rules describing how to transmit data and process the received data. The protocol is used to establish a communication or connection between nodes or endpoints (in the example given herein, between two hosts—a server host and a client host) so that they can send messages back and forth for a period of time. Protocols are normally defined in a layered manner, organized into different levels. The communication governed by the protocols is typically organized as packets or blocks of data sometimes referred to as protocol data units (PDU), with each PDU being organized into a header part and a payload part or service data unit (SDU). Communications typically comprise a serial succession of multiple PDU's. Communication protocols, for example, define the procedures which determine how the PDU will be processed at the transmit and receive nodes.

In typical communications throughout a network, port numbers are frequently used in conjunction with network addresses. As is known in the art, a port number represents an endpoint or a “channel” for network communications. Port numbers allow different applications on the same network system to utilize network resources without interfering with each other. Taken together with a network address, a port number identifies both a host and a “channel” within that host where network communication will take place. Typically, the same set of port numbers are used by different hosts.

In another aspect, network flow analysis is performed on network packets, herein referred to as the fundamental unit that a network uses to transfer information such as application data or application flows between host computers, such as those located in the data center 14 and the client 12. Included in such information detected or otherwise captured by monitoring stations 60, 62 and 66, are conventional information items, including protocol IDs, the port or selector, the network address and the MAC address of the one or more servers at data center 14, as well as the one or more client servers at client 12.

In one instance, it is helpful to measure, correlate, and analyze network flow activity from (both) ends of network 10 to get an accurate picture of the network and the application performance characteristics. Further, such analysis must be coordinated with the usage of the application to provide effective analysis of network and application performance characteristics. Correlation processing of the network flow activity using multiple captures (by one or more monitoring stations) is a process-intensive function that is difficult to perform in real-time (which, in one instance, is defined as within a few seconds of the actual event or activity). Accordingly, it is generally preferred that the monitoring stations 60, 62 and 66 include synchronizing functionality so as to perform for example, synchronized network captures, allowing the synchronized captured data or the global flow ID or both collected from various observation points throughout the network, to be sent to a flow analysis center (preferably located some where in network 10) where the synchronized network captures are correlated to provide an accurate picture of the network activity. Various observed flow-related measurements, metrics (i.e. network delay, server delay, jitter etc.) and associated performance and utilization data points are gathered by the flow analysis center in a conventional manner, along with the global flow ID.

It is important, that the synchronized network captures are reported to the analysis center as quickly as possible, preferably in real-time, in order to provide an effective tool for network management. As will be seen herein, the present invention provides heretofore unattainable service to the analysis center, allowing the synchronized network captures to be correlated and presented to the user (i.e. personnel at the analysis center) in real-time.

However, if the full, complete synchronized network captures are transmitted to the analysis center, the added network loading, in addition to “normal” network traffic, can comprise a significant intrusion, disrupting network activities, especially in networks having a relatively high volume of network traffic. As will be seen herein, the present invention greatly reduces the amount of information transferred across the network to the analysis center, thereby significantly relieving increased network congestion associated with prior art network analysis. For example, it is preferred, in one instance, that only various observed flow-related measurements, metrics (i.e. network delay, server delay, jitter etc.) and associated performance and utilization data points be sent to the analysis center, along with the global flow ID.

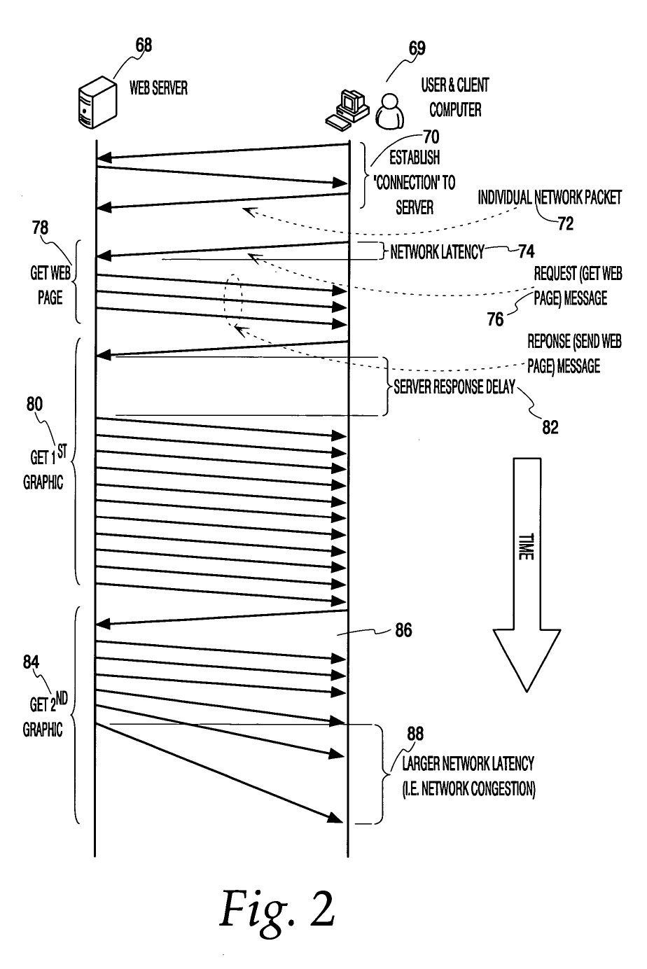

Referring now to FIG. 2, a schematic diagram of communications between a web server 68 at data center 14 and a user 69 at client 12, is shown. Contained in the diagram of FIG. 2 is a series of information flows which are monitored at monitoring stations 60, 62 and 66, and which are analyzed at the analysis center. It should be understood that the individual components of each information flow will be observed and reported to the analysis center by each of the monitoring stations 60, 62 and 66. It is important, therefore, that each report to the analysis center provide a clear network-wide unique identifier for each individual component of each information flow.

In step 70, mutual connection is established between the web server at data center 14 and the client server at client 12. As indicated as 72, individual network packets are being transmitted between the network and the end points. Note the network latency indicated at 74, associated with the step 76 of a request message to get a web page from the web server at data center 14. In step 78, a web page is obtained from the web server in a response message 78. In step 80, a first graphic is obtained by the user. Note the server response delay indicated at 82. In step 84, a second graphic is obtained by the user. Note the decreased server response delay indicated at 86. An exemplary network latency attributed to network congestion is indicated at 88.

The ability to accurately measure the performance a user is experiencing requires complex techniques using the latest technology and toolsets. Traditionally, application data is obtained from a network by “tapping” the wire and recording “packets” (the fundamental unit a network uses to transfer information between computers). In the present invention, network packets are captured using conventional techniques, and are processed to derive and transmit in real-time, a unique identifier for each component of the information flow referred to herein as a “global flow ID”. The global flow ID for a particular information component is unique throughout the entire network and the same information component monitored by the multiple monitoring stations 60, 62 and 66 will be uniquely identified with the same unique global flow ID. In this manner, network and networked application problems can be diagnosed from multiple points in a network. The network traffic (e.g. packets) captured from the multiple monitoring station points can be reliably correlated to obtain the data necessary to analyze interactions throughout the network, using known techniques.

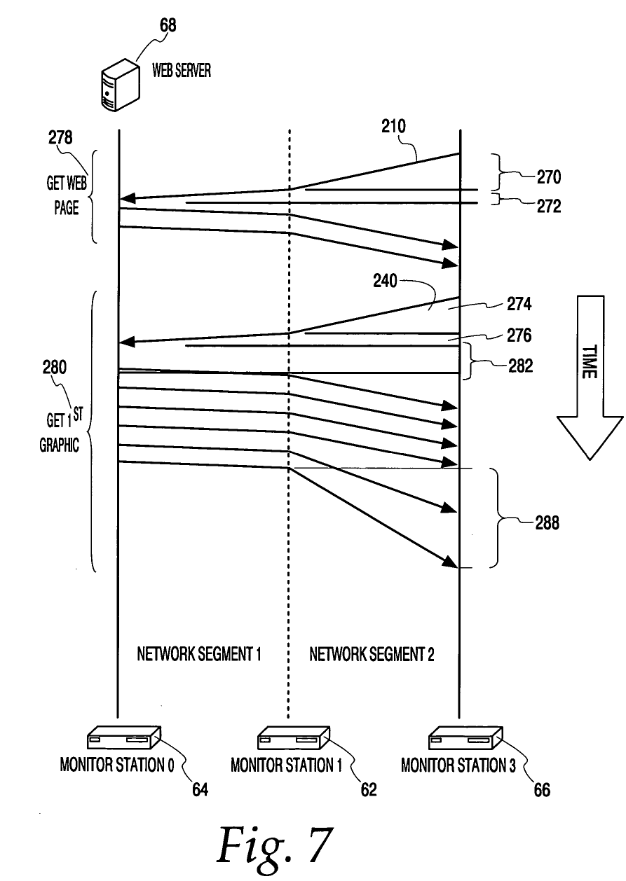

Referring now to FIG. 7, a schematic diagram of a second set of communications between web server 68 and client 12 (FIG. 1) is shown. Contained in the diagram of FIG. 7 is a series of information flows which are monitored at monitoring stations 62, 64 and 66 and which are analyzed at the analysis center (not shown). Each monitoring station 62, 64 and 66 contains flow monitoring and reporting software which identifies flow characteristic data and flow creation timestamp data as will be discussed herein. In step 210 a user at client computer 12 requests a web page from web server 68. As shown in FIG. 7, in step 278 web server 68 acknowledges a message from a user at client computer 12 and responds by sending a web page to the user. In step 280, web server 68 in response to a message from the user, sends a series of data transmissions to the user, herein indicated as being associated with sending a first graphic to the user.

Numeral 270 identifies network latency in network segment 2, between monitoring station 62 and monitoring station 66. Numeral 272 identifies network latency of network segment 1 located between monitoring stations 64 and monitoring station 62. These network latency values are compared to network latency 274 attributed to network segment 2 and network latency 276 attributed to network segment 1, when the user requests a first graphic or otherwise initiates an exchange in which a first graphic is sent, in response to the user at client computer 12. Reference numeral 282 indicates web server latency, or the time taken for web server 68 to respond to the message sent by the user in step 240. Web server 68 responds by sending six transmissions as indicated FIG. 7. The first four of these transmissions contain similar network latency values. In the final two dated transmissions, network latency attributed to network segment 1 is the same, but network latency attributed to network segment 2 increases dramatically as indicated by network latency 288. By analyzing network flow data for the entire network, a cause for latency 288 can be determined. In the example given in FIG. 7, network latency 288 is attributed to network congestion in network segment 2, causing the increased time delays experienced by the user at client computer 12.

With reference to the illustrated network and information flow examples presented herein in FIGS. 1 and 2, it can be seen that it is important to obtain reliable correlation of network traffic between endpoints of a network flow, as this can afford accurate measurements which outline the performance of each infrastructure component. Thus, a network engineer, for example, given the task to solve a complaint of an application “being slow” will begin by having two or more conventional network analyzers, or network application performance analyzers such as the Nexvu Analyzer 2.3 commercially available from Nexvu Technologies of Schaumburg, Ill., installed in the network. The network analyzer referred to herein preferably comprises a device attached to the network which collects networked information and computes measurements of interest such as application response time, jitter, network delay and server delay for those responsible for administering the network.

In one instance, at least two such network analyzers are provided, at the endpoints of interest. For the example given, at least one network analyzer would be installed in the location of the affected end-user (herein client 12) and within the data center 14 where the business networked application is served. With instrumentation at the endpoints of a networked application, a complete and accurate representation of the application components can be obtained. By correlating the network traffic between the endpoints of a network flow, accurate measurements outlining the performance of each infrastructure component can be analyzed.

With the present invention, high traffic density environments, such as those networks used to carry IP telephony and video, where a call may last for hours, can be satisfactorily analyzed. As pointed out above, with the present invention, analysis even of high traffic flows, is made possible because a global flow ID according to principles of the present invention is created, assigned and communicated in real-time along with a minimum of report information with greatly reduced additional flow. The global flow ID according to principles of the present invention provides heretofore minimized intrusion to network traffic, since repeated transmission of the flow per se is not necessary.

In one aspect, the global flow ID is used as a numerical identifier for each information flow to uniquely identify each flow component classified by the monitoring station. The global flow ID is calculated, in one instance, by combining two types of numerical entities comprising one or more flow characteristics and, for the second type, a timestamp related to the network flow of interest. The message digest preferably is carried out according to a well-known Message Digest 5 transformation, or MD5 security hashing algorithm. The computed MD5 message digest or hash value is calculated based upon the observed flow characteristics and timing of the network flow of interest. The MD5 hashing algorithm is well known and was developed by Ron Rivest of MIT in 1991. Preferably, a global flow ID hash value, which is unique to a network flow, is calculated only once per flow, most preferably when a new network flow is detected but could also be indicated by a timestamp at another point in a message flow, as may be desired.

The second numerical entity combined with the computed MD5 message digest is the network's observation of the timestamp for an event related to the network flow of interest, preferably, at a point in time relating to the creation of the network flow. In one example, when the well-known TCP protocol is used for a network flow, creation of the network flow is indicated by the SYN or synchronization protocol, established during the conventional three-way handshake. Thus, a packet sniffer or other instrument or software is used to monitor network traffic for the presence of the synchronization or SYN packet, with the time of such detection being noted as the creation timestamp for the network flow of interest. Protocols other than the TCP protocol may not define the start of a network flow in the same manner. However, by parcing the header data for such protocols, an indication of the beginning of a network flow can be obtained using conventional procedures.

The timestamp may be obtained, for example, along with the flow characteristics, by proprietary network flow classification software (such as NetFlow commercially available from CISCO Systems, Inc. of San Jose, Calif.), located at each monitoring station, for example. If desired, aggregation reports from NetFlow may be outputted to CISCO FlowCollector and NetFlow Data Analyzer software located, for example, at an analysis center to be discussed herein. If desired, MeterFlow software, commercially available from Hifn on Los Gatos Calif. could also be used for data collection of the flow characteristics, timestamp, and other inputs to the hash algorithm as may be desired.

As mentioned, the MD5 message digest is calculated based in part upon flow characteristics observed by the network. Preferably, these flow characteristics include one or more of the following:
1. The list of protocol IDs (32-bit integers) (up to 12) for the network flow.
2. Server Port/Selector—The port/selector (16-bit integer) being used by the “server” host for the network flow. Depending on the network protocols being used by the flow, the term “port” or “selector” has slightly different meanings, but is always used to refer to a specific endpoint on a logical connection to/from a network host.
3. Client Port/Selector—The port/selector (16-bit integer) being used by the “client” host for the network flow. Depending on the network protocols being used by the flow, the term “port” or “selector” has slightly different meanings, but is always used to refer to a specific endpoint on a logical connection to/from a network host.
4. Server Network Address—The network address (32-128 bits) being used by the “server” host for the network flow. If the network flow does not use a network layer address, then this component part may be empty, and of desired a Media Access Control (MAC) address can be used instead.
5. Client Network Address—The network address (32-128 bits) being used by the “client” host for the network flow. If the network flow does not use a network layer address, then this component part may be empty, and a MAC address can be used instead, if desired.
6. Server MAC Address—The physical hardware or Media Access Control address (48-bits) being used by the “server” host for the network flow. This component part is only used if the network flow's Server Network Address is empty.
7. Client MAC Address—The physical hardware or Media Access Control address (48-bits) being used by the “server” host for the network flow. This component part is only used if the network flow's Server Network Address is empty.

As used herein, the term “protocol ID” refers to those values contained in the usual manner, in a directory of all known protocols that the monitoring station is able to classify. The following exemplary flow protocol classification pertains to a common web application flow. The protocol list ETHER2.IP.TCP.HTTP. contains the customary numeric elements as looked up by name, from the monitoring station's protocol directory, that correspond to each of the flow classified protocols.

As noted above, it is generally preferred that the network layer address for the server (e.g. the application server at data center 14) and the client be used in computing the MD5 message digest. However, if these values are not available, then it is preferred that they be substituted with the MAC address for the server host and the client host.

The first 32 bits of the generated digest byte-array is combined, preferably by addition, to the high order 48-bits of the flow's creation observation millisecond timestamp (64 bit). As will be seen, this 16 bit shifted-down timing mechanism allows 65 second granularity for correlating flows. Further consideration will now be given to certain aspects of the global flow ID computation. As mentioned, the global flow-id is computed by combining two numerical inputs: the MD5 digest that has been computed over the network application flow input parameters and the flow's observed timestamp. In one instance, the MD5 digest is preferably a 32-bit integer while the timestamp is preferably a 64-bit integer value defined as the number of milliseconds since midnight Jan. 1, 1970, (commonly known as “the epoch”).

In the preferred embodiment, before adding the two values together, the time stamp is “shifted-down” 16 bits (or “right-shifted using the program operator “>>” in most languages). This operation causes the time stamp to lose 16 bits or 65,536 milliseconds of precision or “granularity” (nearly 66 seconds). This feature allows different monitor stations that are time synchronized within 65 seconds of each other to compute the same 48-bit time stamp value for processing. Alternatively, other implementations could right-shift lesser values to reduce precision loss, although it would increase the need for greater time synchronization requirements (e.g.: a 15-bit right-shift would result in approximately 33 seconds of granularity to be used, and so on).

Referring again to the preferred embodiment, once the time stamp processing is complete, the 32-bit integer message digest value and the 48-bit integer time stamp value are combined and stored in a 64-bit long integer value. This result value is used as the global flow-id for the network application flow. The result value may in some instances “overflow” 64-bits, but this is acceptable since the overflowed value is always deterministic in modern computing systems. The numerical characteristics of the global flow ID are preferably not considered in the preferred system, but is only used as a unique identification value for the flow, thereby making numerical overflow irrelevant. If multiple monitoring stations are time-synchronized within this skew, they will each generate the same global flow ID for the same observed physical network flows. The combined values may cause 64-bit overflow, but this is not important since the “wrapped” value is still deterministic.

Using the Global Flow ID technique described here provides a cost-effective, significantly loose, time synchronization requirement among the monitoring stations. This eliminates the need for expensive hardware that would synchronize the monitoring stations clocks to 100ths of a second accuracy. Brix Networks of Chelmsford, Mass. offers a set of commercially available hardware appliances that provide this timing accuracy in their Brix Verifier line. Commercially available software and equipment from NEXVU Technologies of Schaumburg, Ill. allows corporations, telecom and cable carriers to use cost-effective standard server class hardware thus reducing the expense and maintenance required for a network wide deployment.

The global flow ID, in one instance, is associated with the network application flow for the duration of that flow and is saved to persistent storage for reporting and interactive analysis purposes.

As mentioned, the global flow ID is preferably computed using a timestamp value which can be arbitrary, but preferably indicates the observed time of creation of a network flow. A global flow ID also uses one or more flow characteristics which preferably comprise some observed measurement or performance indicator associated with the network flow of interest. In one instance, seven flow characteristics were identified, with two of the seven being used in the alternative. It is generally preferred that at least three flow characteristics be used for relatively small networks, i.e. networks having either a single server or a single client. It is also generally preferred that at least five flow characteristics be used for larger networks in order to insure that the global flow ID so calculated has sufficiently strong uniqueness. If desired, additional flow characteristics can be used to calculate the global flow ID and this will, generally speaking, result in a stronger uniqueness for the global flow ID. However, the use of five flow characteristics for relatively large networks has been found to provide sufficient uniqueness in a global flow IDs calculated. If desired, global flow IDs using fewer then the preferred number of flow characteristics can be used, although uniqueness of the calculated global flow ID will be reduced somewhat. This means that given a stastically large number of global flow ID calculations one or more global flow IDs for different network flows might be the same. Further, if desired, the network flow timestamp value can be omitted from the global flow ID calculation, although this is not preferred for most situations. Of course, timestamp values and flow characteristics other than those described herein can be used to calculate a global flow ID, and such is contemplated by the present invention.

In the alternative, the timestamp value can be considered as one of the flow characteristics and can be used in place of or replaced by one of the other flow characteristic values, as may be desired. It is however generally preferable that at least four flow characteristic values be used as inputs to the hash algorithm for computing the global flow ID, for relatively simple networks having either a single client, or a single server, or both. It is generally preferred that at least six flow characteristic values be used for larger or more complex networks i.e. networks having a server and more than one clients or a client and more than one server. Again, global flow IDs can be calculated having fewer than the preferred number of flow characteristics as inputs to the hash algorithm although uniqueness of the global flow ID may be compromised to some extent. Alternatively, more than the preferred number of flow characteristic inputs through the hash algorithm can be used, although generally speaking, this has not been found to be necessary.

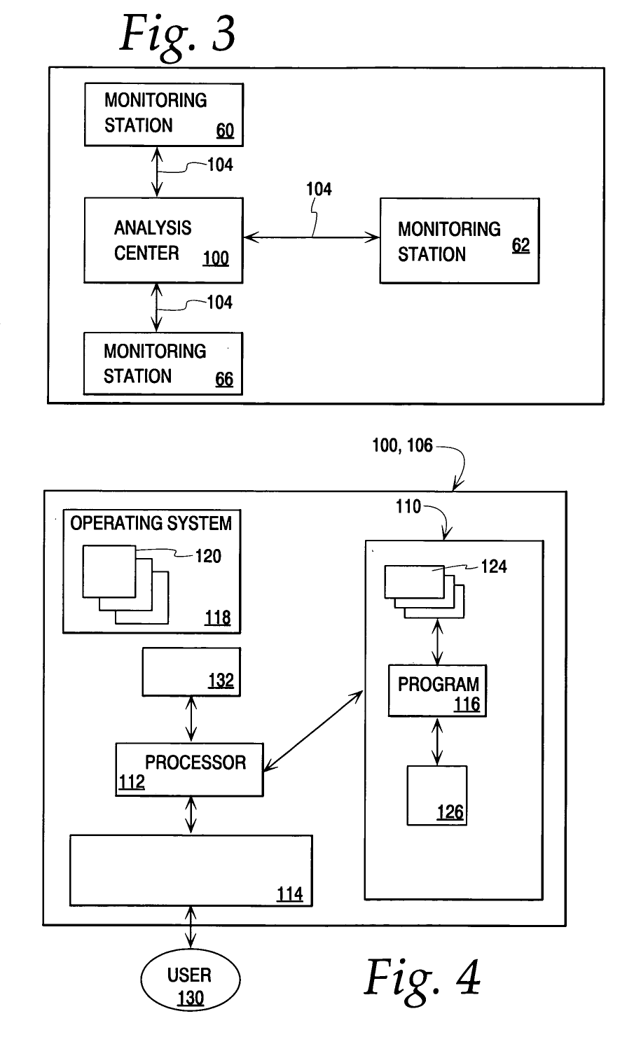

Turning now to FIG. 3, a schematic representation of a portion of network 10 is shown. The portion indicated in FIG. 3 shows an analysis center 100 and the monitoring stations 60, 62 and 66. Schematically indicated in FIG. 3 are network connections 104 between the monitoring stations and the analysis center.

Turning now to FIG. 4, analysis center 100 includes system apparatus which embodies a flow analysis system 106. In one example, flow analysis system 106 comprises one or more storage devices 110, one or more processors 112 and one or more interface components 114. The processor 112, in one example, comprises a central processor unit (“CPU”). The processor 112 executes one or more instructions of one or more programs 116, under control of an operating system 118, employing one or more system programs 120. The one or more programs 116, in one example, comprise one or more subroutines and one or more variables, as will be understood by those skilled in the art. The storage device 110, in one example, comprises at least one instance of a recordable data storage medium, as described herein. The storage device 110 stores the program 116 and, optionally, one or more data bases 124 and one or more data files 126.

The interface component 114, in one instance, comprises a graphical user interface (“GUI”). In one example, the interface component 114 allows a network engineer, network manager, or other user 130 to execute one or more programs 116. The one or more programs 116, in one example, comprise one or more subroutines to carry out flow analysis methods and operations described herein. In one instance, program 116 includes one or more subroutines to collect, publish, interpret or otherwise process information which supports aspects of operation of the flow analysis activity. For example, program 116 includes one or more subroutines for implementing the acquisition of network flow data and the calculation of the global flow ID according to principles set out herein. In another example, interface component 114 allows the user 130 to verify or otherwise interact with the input variables for the global flow ID calculation. In yet another example, the interface component 114 allows a user 130 to execute one or more test harnesses or other test routines useful for monitoring, analyzing and managing network 10. Preferably, interface component 114 includes a display device and a data input device (not shown) which allows a user 130 to set up the flow analysis center 100 according to desired operating objectives. With the interface component 114, a user can access, read or write to the one or more programs 116, as well as the optional data bases 124 and data files 126. It is generally preferred that communication between the analysis center and the monitoring stations be performed over network 10, using conventional communication techniques, and an optional communications port 132 can be employed, if desired.

A flow analysis system 100, in one example, comprises a plurality of components such as one or more electronic components, hardware components and computer software components. A number of such components can be combined or divided in the flow analysis system 100. An exemplary component of the flow analysis system 100 employs or comprises a set or series of computer instructions written in or implemented with any of a number of program languages, as will be appreciated by those skilled in the art. A flow analysis system in one example, comprises any orientation (e.g. horizontal, oblique or vertical) with the description and figures herein illustrating one exemplary orientation of the flow analysis system 100, for explanatory purposes.

Systems, articles, and apparatus contemplated by the present invention preferably comprise digital devices, but could also comprise analog or hybrid electronic or non-electronic devices, as may be desired. One or more systems for creating and transmitting the global flow ID comprise either one or a plurality of components such as one or more electronic components, hardware components, and computer software components. A number of such components can be combined or divided at various locations, throughout network 10 as may be desired. An exemplary component of analysis system employs or comprises a set or series of computer instructions written in or implemented with any number of programming languages as will be appreciated by those skilled in the art.

The flow analysis system 100, in one example, employs one or more machine-readable (or “computer-readable”) signal-barring medium. The computer-readable signal-barring media stores software, firmware, or assembly language for performing one or more portions of one or more embodiments of the invention. One example of a computer-readable signal-barring medium for the flow analysis system 100 comprises a storage component such as one or more storage devices 110. Other examples of a computer-readable signal-barring medium for the analysis system can comprise, for example, one or more of a magnetic, electrical, optical, biological, or anatomic data storage medium. For example, the computer-readable signal-barring medium can comprise floppy disks, magnetic tapes, CD-ROMs, DVD-ROMs, hard disk drives and electronic memory. In another example, the computer-readable signal-barring medium comprises a modulated carrier signal transmitted or a network comprising or coupled with the analysis system, for instance, one or more of a telephone network, a local area network, a wide area network, the internet, and a wireless network.

Turning now to FIG. 5, a schematic representation of a flow analysis method according to principles of the present invention is shown. In step 140, the flow analysis method is started upon detecting a new network flow at one of the monitoring stations 60, 62 or 66. For the arrangement illustrated in FIG. 1, each of the monitoring stations are preferably synchronized using conventional techniques, and each detects the same new network flow and each operates to produce the same global flow ID for that newly detected network flow. In step 142, data is acquired from the new network application flow. Preferably, the acquired data includes the parameters for the global flow ID calculation, discussed herein.

A mechanism must be provided to parse network packets or protocol data units header and payload information in order to “classify” data by its encapsulated protocols. Those skilled in the art are aware of well-documented formats for industry standard protocols used on typical enterprise networks. There are many such network classification modules and commercially available within the industry for such tasks. All follow the well-documented formats for each packet and parse its component values to determine the protocol hierarchy for each application flow. For example, if the physical medium for the monitored network is known to be “Ethernet-II”, the classification module examines the first 16 bytes of the packet header. Certain fields within this header indicate what the successive protocol or payload data is. This algorithm is repeated for each encapsulated protocol using succeeding data within the packet header until all header data is exhausted and all protocols are classified. For some protocols, additional information may be derived by examining the packet's application payload data as well.

In step 142 data can be acquired using functionality entitled NetFlow™ within networking equipment commercially available from Cisco®. If desired, other techniques can be employed to acquire the data needed to input the global flow ID calculation. For example, in an environment where multiple monitor stations are distributed throughout the enterprise network and additionally store all network flow information in a local database at every station, a mechanism could be used to correlate network application flows by querying each station's database explicitly for a targeted flow's required parameters. In such an alternative configuration, all stations must be time synchronized using Network Time Protocol (NTP) or other such well-known real-time clock synchronization software.

Flow information is then selected from such a relational or other database at each station using a range of time and other parameters that make the targeted flow unique. As stated above, these uniquely identifying parameters for a network application flow includes flow's start time, all associated protocol IDs, server port/selector, client port/selector, server network address, client network address, server MAC address and client MAC address.

All selected measurement & observation information such as network utilization, jitter, response time and other performance metrics are then transferred to the analysis center for visualization & analysis. The same process of querying is applied to each monitoring station for the targeted flow under analysis in succession. All gathered information from each monitor station is then compared to the likewise selected information from other monitor stations at the analysis center. Methods for visualization, comparison, troubleshooting and analysis of such data are broad and vary according to the type flow being analyzed. The invention provides an aid to such correlation of distributed measurements and schemes for correlating their analysis. In step 144, some or all of the acquired data is utilized to prepare a unique data identifier, or network application flow identifier, herein referred to as a global flow ID. In step 144, the MD5 message digest is calculated according to principles set out herein. In optional step 146, the global flow ID is bound to the network application flow. This binding or other type of association is preferably kept permanently to allow reference for historical analysis.

In step 148, the global flow ID is used at the analysis center to correlate and analyze the network application flow and related network response characteristics associated with the variously locally detected observations of the network application flow. In step 150, analysis of network 10 is concluded.

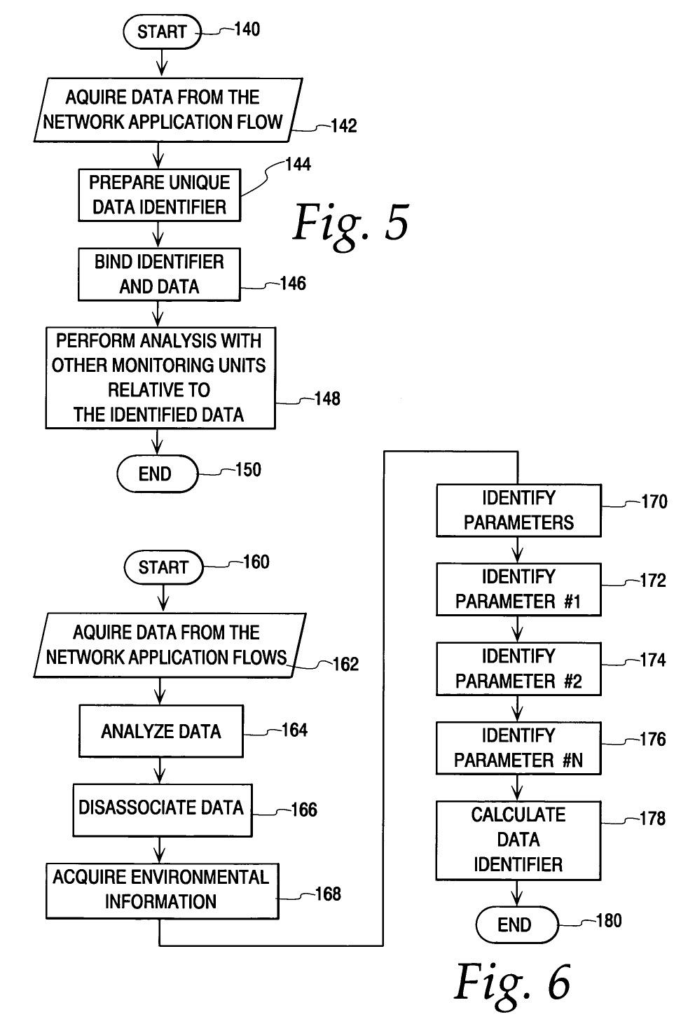

Referring now to FIG. 6, preparation of the unique data identifier or global flow ID is shown in greater detail. In step 160, global flow ID preparation is initiated upon detecting a new network application flow. In step 162, raw data from the network application flow is acquired, analyzed in step 164 and disassociated in step 166. As mentioned above, steps 164 and 166 are preferably carried out using commercial software specially developed for the purpose of providing parameters of the type used as inputs to the global flow ID calculation, as set out herein. In step 168, any necessary environmental information, such as the current network time, is obtained. In step 170 the parameters needed as input to the global flow ID calculation are identified using, for example, a lookup table.

In steps 172-176 the individual parameters are defined, and in step 178 are incorporated into the calculation of the global flow ID. As mentioned herein, in step 178 calculation of the data identifier or global flow ID is preferably carried out using conventional MD5 hash algorithm techniques. The method is concluded in step 180 when the global flow ID is created, stored if desired, or otherwise made ready for future use.

When users experience poor performance of critical business networked applications, it is generally the responsibility of the network engineer to identify the source of the problem and resolve any network issues. In today's complex corporate IT infrastructure the identification of an issue can be a complex and time consuming endeavor. The delivery of the networked application encompasses a myriad of computing components (i.e. servers, databases, network, desktop PCs, etc.) interoperating to provide the end-user with the experience they expect. The challenge to the IT staff (i.e. network engineer) responsible for the resolution of a performance issue becomes the isolation of the issue with partial visibility and understanding into all facets of the infrastructure.

The first step in the problem resolution process is to pinpoint the source of the problem. Performance issues are especially difficult to diagnose without the obvious server crash or network traffic flood. Using flow analysis techniques and gaining visibility into the system interactions illustrated in FIG. 2, a technician (i.e. network engineer) at the analysis center can immediately isolate issues to the network (i.e. congestion), the application servers (including the database servers) or the client workstation using/comparing flow metrics identified by the global flow ID reported by each monitoring station. As shown in FIG. 2 examples of two potential issues are given. One is a potential server or application problem. The server response delay (82) for the first graphic request is significantly higher than the web page request and other graphic request. This may be a server problem where the server processing demand was high at that time or the application may not be optimized and the first graphic may be difficult to retrieve by the server. A greater sampling by each monitoring station, of request to that specific web page and identified by the global flow ID will help further diagnose the source of the problem. At this point the technician has identified the general location of the issue for further analysis by a skilled server technician or application developer (i.e. web developer).

Another issue illustrated in FIG. 2 is observed in the second graphic request (84). The response from the server is exhibiting larger than normal network delays (88). At this point deeper analysis into the network is required.

Employing a multi-monitoring station approach as shown in FIG. 1 provides greater visibility into the performance of various network segments. This is particularly important in large networks that span large geographical distances (i.e. New York to Los Angeles). Using a multi-monitoring station approach, the ability to further isolate network problem areas can be accomplished within seconds (i.e. real-time—while the problem is occurring). FIG. 7 illustrates the ability to breakdown network latency (delay) into segments. This is critical to network engineers and managers who are trying to understand how much bandwidth they need to purchase for critical network connections that are shared among many users (i.e. an Internet connection in an office). Networks can be segmented into two general types. The Local Area Network (LAN) that interconnects all computers in an office. This type of network tends to be very reliable and fast. The other type of network segment is a Wide Area Network (WAN). This type of network segment interconnects offices in different geographical regions (i.e. New York to Los Angeles). This type of network is significantly more expensive to operate and is shared among all users in each office. It tends to be much lower speed than the office network and experiences more congestion. Isolating and documenting performance problems between the two network segments is critical because the administration of the two are most often provided by different companies.

Alternatively, in an environment where multiple monitor stations are distributed throughout the enterprise network and additionally store all network flow information in a local database at every station, a mechanism could be used to correlate network application flows by querying each station's database explicitly for a targeted flow's required parameters. In such an alternative configuration, all stations must be time synchronized using Network Time Protocol (NTP) or other such well-known real-time clock synchronization software.

Flow information is then selected from such a relational or other database at each station using a range of time and other parameters that make the targeted flow unique. These uniquely identifying parameters for a network application flow, in one example, includes flow's start time, all associated protocol IDs, server port/selector, client port/selector, server network address, client network address, server MAC address and client MAC address.

All selected measurement & observation information such as network utilization, jitter, response time and other performance metrics to be identified by the global flow ID are then transferred to the analysis center for visualization & analysis. The same process of querying is applied to each monitoring station for the targeted flow under analysis in succession relying on the global flow ID technique to ensure valid correlation. All gathered information from each monitor station is then compared to the likewise selected information from other monitor stations at the analysis center. Methods for using the flow-related data to be identified by the global flow ID (e.g. visualization, comparison, troubleshooting and analysis of such data) vary according to the type flow being analyzed. The invention provides an aid to the correlation of such data and to the schemes for correlating their analysis.

The present invention provides network systems with heretofore unattainable capabilities. Consider, for example, multi-monitoring station real-time measurement correlation. Products can now be created that provide a network engineer/technician with the ability to obtain multi-point measurements along the path of a data network conversation. Using multi-point instrumentation with measurement correlation allows finger granularity for monitoring and analysis of a network. Measuring critical LAN and WAN segments individually becomes trivial, allowing proactive and immediate problem identification.

Alternatively, a Global Flow ID could enable other products that may simply map traffic patterns within a network. A very low cost product could be developed to track traffic flow. This would be useful for managing large networks with complex interconnect topologies.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A system for providing a network flow analysis using a global flow ID uniquely identifying a network application flow traveling in a network between a server host and a client host and having at least one of the following characteristics: at least one protocol ID for the network application flow, a port used by the server host, a port used by the client host, a network address or a media access control address used by the server host for the network application flow, and a network address or a media access control address used by the client host for the network application flow, the system comprising:
at least one monitoring station;
the at least one monitoring station including a module for monitoring the network application flow;
the at least one monitoring station including a module for obtaining from the network application flow at least one of the characteristics of the network application flow;
the global flow ID comprising a message digest;
the at least one monitoring station including a module for calculating the global flow ID with a hashing algorithm, using one or more of the network application flow characteristics and a network timestamp as inputs to the hashing algorithm;
an analysis center for analyzing the network application flow; and
the at least one monitoring station further including a module for transmitting the global flow ID to the analysis center.

2. The system according to claim 1 comprising a plurality of spaced-apart monitoring stations, each calculating the same global flow ID for the same network application flow.

3. The system according to claim 1 wherein the at least one monitoring station further includes a module for binding the global flow ID to the network application flow.

4. The system according to claim 1 wherein no more than 12 protocol IDs are used as inputs to the hashing algorithm.

5. The system according to claim 1 wherein a network address used by the server host is used as an input to the hashing algorithm.

6. The system according to claim 5 wherein a network address used by the client host is used as an input to the hashing algorithm.

7. The system according to claim 1 wherein a media access control address used by the server host is used as an input to the hashing algorithm.

8. The system according to claim 7 wherein a media access control address used by the client host is used as an input to the hashing algorithm.

9. A method for analyzing a network application flow traveling between a server host and a client host and having at least three of the following flow characteristics: at least one protocol ID for the network application flow, a port used by the server host, a port used by the client host, a network address or a media access control address used by the server host for the network application flow, and a network address or a media access control address used by the client host for the network application flow, the method comprising:
observing the network application flow;
obtaining from the network application flow at least one of the flow characteristics of the network application flow;
calculating a global flow ID unique to the network application flow with a hashing algorithm to create a message digest comprising the global flow ID, using at least three of the flow characteristics and a network timestamp related to the network application flow, as inputs to the hashing algorithm;
providing a network analysis center for analyzing the network application flow; and
transmitting the global flow ID to the network analysis data.

10. The method according to claim 9 wherein no more than 12 protocol IDs are used as inputs to the hashing algorithm.

11. The method according to claim 9 wherein a network address used by the server host and a network address used by the client host are used as inputs to the hashing algorithm.

12. The method according to claim 9 wherein a media access control address used by the server host and a media access control address used by the client host are used as inputs to the hashing algorithm.

13. The method according to claim 9 wherein the hashing algorithm comprises an MD5 algorithm.

14. A method for analyzing a network application flow traveling between at least one of the server host and the client host and at least two of the other of the server host and the client host and having at least five of the following flow characteristics: at least one protocol ID for the network application flow, a port used by the server host, a port used by the client host, a network address or a media access control address used by the server host for the network application flow, and a network address or a media access control address used by the client host for the network application flow, the method comprising:
observing the network application flow;
obtaining from the network application flow at least one of the flow characteristics of the network application flow;
calculating a global flow ID unique to the network application flow with a hashing algorithm to create a message digest comprising the global flow ID, using at least five of the flow characteristics and a network timestamp related to the network application flow, as inputs to the hashing algorithm;
providing a network analysis center for analyzing the network application flow; and
transmitting the global flow ID to the network analysis data.

15. The method according to claim 14 wherein the hashing algorithm comprises an MD5 algorithm.

16. The method according to claim 14 wherein a media access control address used by the server host and a media access control address used by the client host are used as inputs to the hashing algorithm.

17. The method according to claim 14 wherein a network address used by the server host and a network address used by the client host are used as inputs to the hashing algorithm.

18. The method according to claim 14 wherein no more than 12 protocol IDs are used as inputs to the hashing algorithm.

19. The method according to claim 14 wherein the timestamp is related to the creation of the network application flow.

20. An article of manufacture including a machine readable medium for causing a computer system to perform a network analysis at a remote network analysis center, using a global flow ID comprising a message digest and uniquely identifying a network application flow traveling in a network between a server host and a client host and having at least one of the following characteristics: at least one protocol ID for the network application flow, a port used by the server host, a port used by the client host, a network address or a media access control address used by the server host for the network application flow, and a network address or a media access control address used by the client host for the network application flow, the article of manufacture comprising:
a module for monitoring the network application flow;
a module for obtaining from the network application flow at least one of the characteristics of the network application flow;
a module for calculating the global flow ID with a hashing algorithm, using one or more of the network application flow characteristics and a network timestamp as inputs to the hashing algorithm; and
a module for transmitting the global flow ID to the network analysis center.
